(19) United States
(12) Patent Application Publication
(10) Pub. No.: US 2020/0324575 A1
(43) Pub. Date: Oct. 15, 2020

(54) NON-PNEUMATIC TIRE HAVING OFFSET SPOKES

(71) Applicants: Damon Lee CHRISTENBURY, Greenville, SC (US); Steven M CRON, Greenville, SC (US); Compagnie Generale des Etablissements Michelin, Clermont-Ferrand (FR)

(72) Inventors: Damon Lee CHRISTENBURY, Greenville, SC (US); Steven M CRON, Simpsonville, SC (US)

(21) Appl. No.: 16/959,088

(22) PCT Filed: Dec. 31, 2018
(86) PCT No.: PCT/US18/68202

§ 371 Date: Jun. 29, 2020

Related U.S. Application Data
(63) Continuation of application No. PCT/US17/69176, filed on Dec. 31, 2017.

(51) Int. Cl. B60C 7/14

(52) U.S. Cl. CPC B60C 7/14; B60C 2007/146

(57) ABSTRACT

A non-pneumatic tire having a resilient annular outer band having a lateral mid-plane positioned equidistant between its left lateral edge and its right lateral edge, a radially inner annular hub; a plurality of spokes connecting the resilient annular outer band to the inner annular hub, wherein each of said plurality of spokes which connect to the resilient annular outer are laterally offset from the lateral mid-plane of the resilient annular outer band.

### FIELD OF THE INVENTION

The subject matter of the present invention relates to a non-pneumatic tire which creates a lateral force as it rolls under load and a method for designing and building such a tire.

### BACKGROUND OF THE INVENTION

The innovation of the pneumatic tire over solid wheels provided increased compliance over uneven terrain, comfort, reduced mass and even rolling resistance. The pneumatic tire however is susceptible to damage, possesses a complex composite structure, and requires periodic maintenance for optimum performance A tire or wheel that improves on a pneumatic tires performance could, for example, provide better compliance, better control over stiffness, reduced maintenance requirements and improved durability.

Non-pneumatic tires or non-pneumatic wheels provide certain such improvements. The details and benefits of non-pneumatic tire or non-pneumatic wheel constructions are described e.g., in U.S. Pat. Nos. 6,769,465; 6,994,134; 7,013,939; and 7,201,194. Certain non-pneumatic tire and wheel constructions propose incorporating a resilient annular outer band or “shear band”, embodiments of which are described in e.g., U.S. Pat. Nos. 6,769,465 and 7,201,194. Such non-pneumatic tire and wheel constructions provide advantages in performance without relying upon the containment of pressurized gas for support of the nominal loads applied to the tire or wheel.

In designing a tire for use on a vehicle, it is desirable to adjust the lateral forces the tire generates as it rolls across the ground. Some of these forces are due to the effect of layering an angled ply over another angled ply. As the reinforcements enter the contact patch, the deformation of the plies result in an asymmetric deformation of the outer tread, resulting in the generation of a lateral force known as ply steer. Such lateral forces can be changed during the design and construction of the tire, such as by adjusting the angles of the reinforcements or making changes to the tread sculpture. Lateral forces can be changed by altering the sidewall height of one side of the tire compared to the other sidewall also known as conicity. Not all such tuning methods may be available on a non-pneumatic tire.

Therefore, new and innovative changes to a non-pneumatic tire and its construction resulting in a non-pneumatic tire that generates a lateral force as it rolls across the ground would be useful. Such a new and innovative change that provides the desired lateral force without alteration of the resilient annular outer band would be particularly useful.

### SUMMARY OF THE INVENTION

Aspects and advantages of the invention will be set forth in part in the following description, or may be obvious from the description, or may be learned through practice of the invention.

In one exemplary embodiment, a non-pneumatic tire possesses a resilient annular outer band having a lateral mid-plane positioned equidistant between at least two lateral edges, the at least two lateral edges comprising a left lateral edge and a right lateral edge; a radially inner annular portion; and a plurality of spokes connecting the resilient annular outer band to the inner annular portion, each spoke having a left lateral edge and a right lateral edge; wherein each of said plurality of spokes which connect to the resilient annular outer band are laterally offset from the lateral mid-plane of the resilient annular outer band.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an embodiment of the invention.

FIG. 2 provides a side view of an embodiment of the invention.

FIG. 3 provides a section view of the embodiment taken on line 3-3 in FIG. 2.

FIG. 4 provides a view of a spoke of a prior art embodiment taken from section taken in the radial and lateral direction of the tire.

FIG. 5 provides a view of a spoke of an embodiment taken from section taken in the radial and lateral direction of the tire.

FIG. 6 provides a front elevation view of a prior art embodiment pressed against a ground surface and positioned with camber.

FIG. 7 shows a computer model of the footprint of three designs of a non-pneumatic tire loaded with 500 daN normal to the surface upon which the footprint is measured, Design 1 representing a witness tire having spokes centered upon the mid-plane of the resilient annular outer band of the tire, Design 2 incorporating an embodiment of the present invention having the spoke offset from the mid-plane of the resilient annular outer band of the tire by 11 mm, and Design 3 having centered spokes like Design 1, but with the tire angled relative to the surface by 1 degree of camber.

FIG. 8 shows an example of the output from the computer program showing the lateral force generated by Design 3 when rolled over a short distance with 500 daN of force against a flat surface.

FIG. 9 provides a view of a spoke of an embodiment taken from section taken in the radial and lateral direction of the tire.

FIG. 10 provides a view of a spoke of an embodiment taken from section taken in the radial and lateral direction of the tire.

The use of identical or similar reference numerals in different figures denotes identical or similar features.

### DETAILED DESCRIPTION OF THE INVENTION

The present invention provides a tire which generates a lateral force upon carrying a given load and rolling across a surface. In particular, the tire generates a lateral force by possessing a plurality of spokes which are offset from the lateral mid-plane of the tire. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“About” or “generally” or “approximately” followed by a number when specifying a value should be understood to mean the number specified and any number that is within plus or minus one unit of the smallest significant digit unless otherwise specified. Under this rule, all non-zero digits are significant, e.g.: 1, 2, 3, 4, 5, 6, 7, 8, 9. Zeros between non-zero digits are significant, e.g.: 102, 2005, 50009. Leading zeros are never significant, e.g: 0.02, 001.887, 0.000515. In a number with a decimal point, trailing zeros (those to the right of the last non-zero digit) are significant, e.g: 2.02000, 5.400, 57.5400. In a number without a decimal point, trailing zeros are not significant. For example, “about 100 cm” is equivalent to 100 cm+/−10 cm. In other words, “approximately 100 cm” would be inclusive of 110 cm and 90 cm and all values in between.

“Axial direction” or the letter “A” in the figures refers to a direction parallel to the axis of rotation of for example, the shear band, tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the resilient annular outer band and/or wheel structure.

“Lateral mid-plane” means the equatorial plane is positioned an equal distance from the lateral edges of the resilient annular outer band.

“Left lateral edge” means the left lateral edge when viewed in the direction of forward travel of the vehicle.

“Right lateral edge” means the right lateral edge when viewed in the direction of forward travel of the vehicle.

“Circumferential direction” or the letter “C” in the figures refers to a direction is orthogonal to the axial direction and orthogonal to a radial direction.

“Forward direction of travel” or the letter “F” in the figures refers to the direction the tire was designed to predominantly travel in for aesthetics and or performance reasons. Travel in a direction different than the forward direction of travel is possible and anticipated.

“Radial plane” means a plane that passes perpendicular to the equatorial plane and through the axis of rotation of the wheel.

“Lateral direction” means a direction that is orthogonal to an equatorial plane.

“Elastic material” or “Elastomer” as used herein refers to a polymer exhibiting rubber-like elasticity, such as a material comprising rubber.

“Deflectable” means able to be bent resiliently.

“Nominal load” or “desired design load” is a load for which the wheel or tire is designed to carry and operate under. The nominal load or desired design load includes loads up to and including the maximum load specified by the manufacturer and, in the case of a vehicle tire, often indicated by marking on the side of a the tire. A loading condition in excess of the nominal load may be sustained by the tire, but with the possibility of structural damage, accelerated wear, or reduced performance.

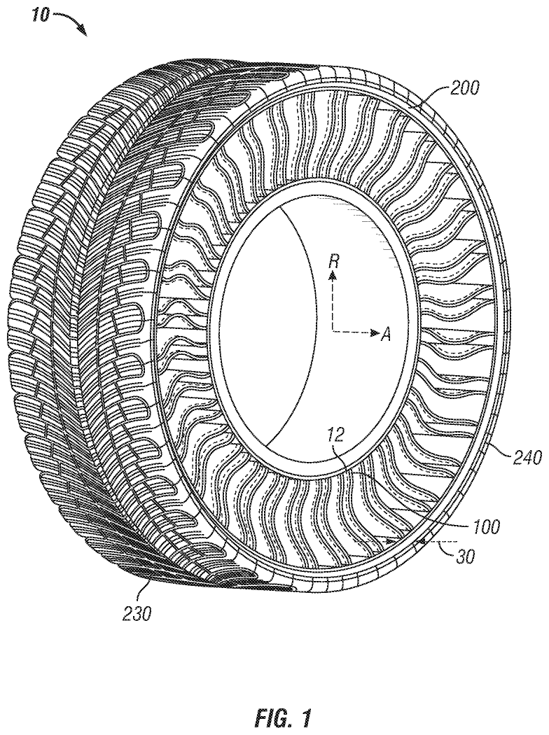

FIG. 1 provides a perspective view of an exemplary embodiment of the invention showing a non-pneumatic tire 10 possessing a plurality of spokes 100 connecting a resilient annular outer band 200 to an inner annular portion 12, shown here as an inner band. In this embodiment, the spokes 100 of the tire provide mechanical support to suspend the inner annular portion 12 within the resilient outer annular band 200. While not shown here, the inner band may be part of a hub to attach the tire to a bearing, axle, or other part of a vehicle so as to allow for rotation about the central axis of the tire 10. In the exemplary embodiment shown, the right lateral edge 140 of each spoke 100 are spaced a distance 30 from the right lateral edge 240 of the resilient annular outer band 200.

Since the right lateral edge 140 of each spoke of the exemplary embodiment lies in a plane parallel with the equatorial plane of the resilient annular outer band and the left lateral edge 150 of the each spoke of the exemplary embodiment lies in a plane parallel with the equatorial plane of the resilient annular outer band, the difference of distance between the right lateral edge of each spoke and the right lateral edge of the resilient annular outer band and the distance between the left lateral edge of each spoke and the left lateral edge of the resilient annular outer band is equivalent to the lateral offset of each spoke from the lateral mid-plane of the resilient annular outer band. In this particular embodiment each spoke is offset the same amount.

In other embodiments, not shown, it is anticipated that each spoke may have a different offset and still be within the scope of the invention, the average position or average offset of all the spokes being not equal to zero. For example, for a repeating pattern of three spokes for a wheel having 54 spokes, the first spoke in the pattern of spokes is laterally offset by 2 cm from the mid-plane of the resilient outer annular band toward the left lateral edge of the resilient outer annular band, the second spoke in the pattern of spokes is offset by 1 cm from the mid-plane of the resilient outer annular band and the third spoke in the pattern of spokes is aligned with the mid-plane of the resilient outer annular band toward the left lateral edge of the resilient outer annular band. In this example, the offset of the plurality of spokes would be equal to ((2 cm×18 spokes+1 cm×18 spokes+0 cm×18 spokes)/54 spokes)=total lateral spoke offset=1 cm lateral offset toward the left lateral edge.

In yet another example for a repeating pattern of three spokes for a wheel having 54 spokes, the first spoke in the pattern of spokes is laterally offset by 3 cm from the mid-plane of the resilient outer annular band toward the left lateral edge of the resilient outer annular band, the second spoke in the pattern of spokes is offset by 1 cm from the mid-plane of the resilient outer annular band toward the right lateral edge of the resilient outer annular band and the third spoke in the pattern of spokes is aligned with the mid-plane of the resilient outer annular band. In this example we presume a convention where a distance toward the left lateral edge is in a positive direction and toward the right lateral edge is in a negative direction. In this example, the offset of the plurality of spokes would be equal to ((3 cm×18 spokes+−1 cm×18 spokes+0 cm×18 spokes)/54 spokes)=total lateral spoke offset about equal to 0.7 cm toward the left lateral edge.

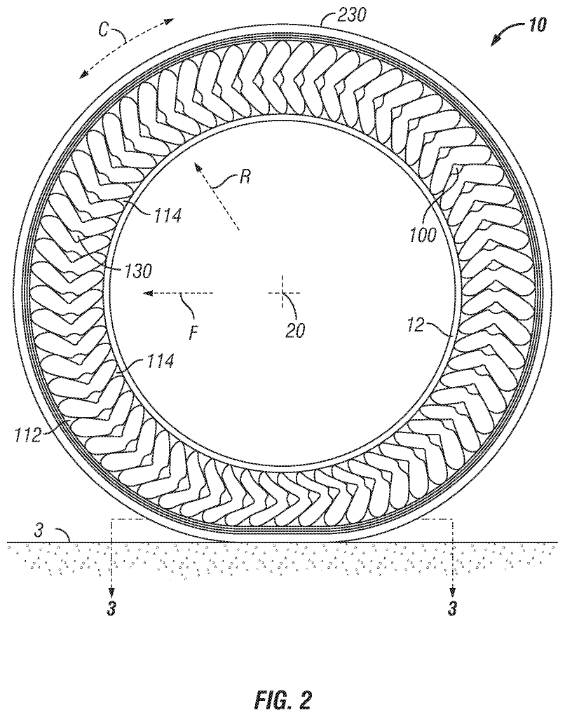

FIG. 2 provides a left lateral view of an embodiment of the invention. Here, a plurality of spokes 100 are shown suspending the inner annular portion 12 from the resilient annular outer band. The spokes of this embodiment have a thickened nose portion 130, and a thickened radially outer portion 112 and a thickened radially inner portion 114. Each spoke 100 is comprised of rubber reinforced with a composite glass resin and may further be reinforced with a cord, such as a polyester cord. The inner band 12 of the present embodiment is noncompliant and constructed from aluminum. The resilient annular outer band 200 is compliant, conforming to the flat ground surface 3 when subject to the desired design load creating a contact patch having a length in the longitudinal direction of the tire and a width in the lateral direction of the tire.

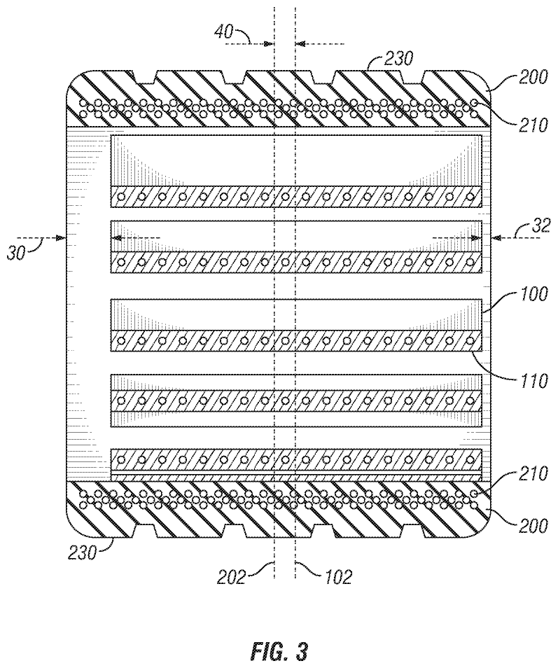

FIG. 3 shows a section view of the embodiment of FIG. 2 taken along section line 3-3 of FIG. 2. The rubber spokes 100 section shows the rubber surrounding a glass fiber resin reinforcements 110 of the spokes. In this embodiment, the glass fiber resin reinforcements 110 lie along the length of the spoke 100 stretching a portion of the distance from the inner annular portion 12 to the resilient annular outer band 200. The resilient annular outer band 200 section shows rubber surrounding glass fiber resin reinforcements 210. The resilient annular outer band glass fiber resin reinforcements 210 extend in the circumferential direction of the resilient annular outer band 200. These reinforcements form three layers, each layer extending in the longitudinal direction and across the width of the tire in the lateral direction. The three layers of glass fiber resin reinforcements 210 form what can otherwise be referred to as the shear layer of the resilient annular outer band 200.

The lateral mid-plane 102 of each spoke 100 of the embodiment is offset from the lateral mid-plane 202 of the resilient annular outer band 200. In the present embodiment, each spoke is offset by the same amount and each spoke 100 is also symmetric about its lateral mid-plane 102 resulting in the lateral offset 40 of the lateral mid-plane 102 of each spoke 100 from the lateral mid-plane 202 of the resilient annular outer band 200 to be equal to the half of the difference of the distance 30 of the left lateral edge of the resilient annular outer band 200 to the left lateral edge of the spoke 100 minus the distance 32 from the right lateral edge of the resilient annular outer band 200 to the right lateral edge of the spoke 100.

The offset of the spokes from the lateral mid-plane 202 of the resilient annular outer band 200 results in a wheel that exhibits a force in the lateral direction. Such a force may be desirable in a tire to modify how the vehicle handles or may be desirable to overcome other lateral forces acting upon the vehicle from the outside environment or from tread sculpture or the effects of the geometry of resilient annular outer band 200 reinforcements 210 such as ply steer. For example, if the tread reinforcement layers are extending in the circumferential direction, but at an angle to the equatorial plane of the tire, such a configuration may result in a residual ply steer torque that could be counteracted by offsetting the spokes toward one lateral direction. In another example, a tread pattern, which may have been chosen for aesthetic reasons, or utilitarian reasons or both, may create a lateral force in a particular direction. Such a force may be counteracted by offsetting the spokes toward one lateral direction. As another example, most roads in North America and in other locations around the world possess a “crown” or curvature extending from one side of the road to the other side. Since cars often tend to drive on one side of the road, for instance on the right side in North America, the car tends to be pulled toward the right shoulder of the road due to the slope of the road in that direction. Offsetting the spokes toward the left of the resilient annular outer tread band will help counter act that force, allowing the vehicle to possess a more neutral feel to the steering wheel when driving on such crowned roads.

To further explain the effects of this invention, a model of a non-pneumatic tire having a resilient annular outer band width of about 165 mm and equivalent to a pneumatic tire size of 205/55R16 was created in a finite element computer program, Abaqus. Three designs were loaded statically to 500 daN normal to the ground surface 3. Each design's footprint shape and contact pressure was then compared. To predict lateral force, the three designs were rolled a short distance to estimate a steady state value of the lateral force generated by rolling.

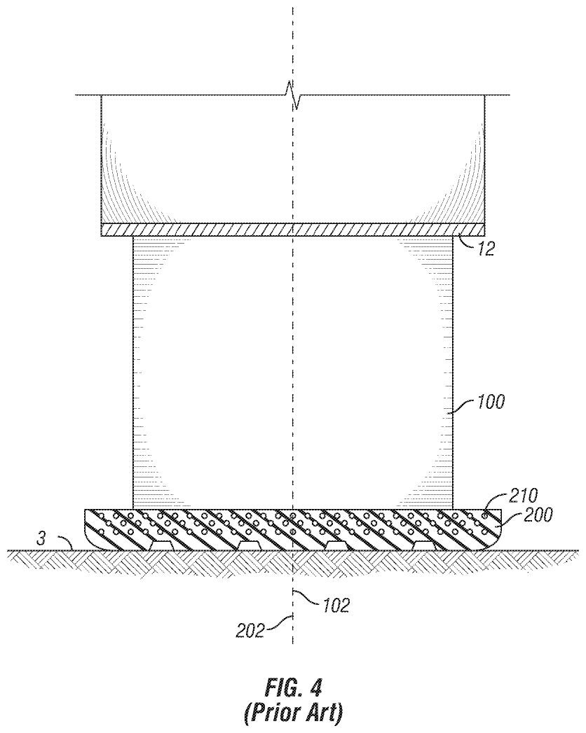

The first of the three designs tested is represented by FIG. 4 wherein the mid-plane 102 of the spokes 100 is aligned with the mid-plane 202 of the resilient annular outer band 200 and the tire is tested at 0 degrees camber.

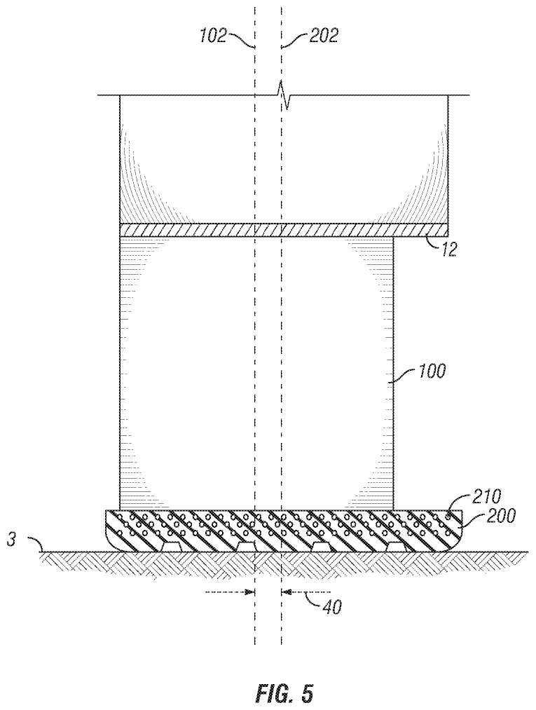

The second of the three designs tested is represented by FIG. 5 wherein the mid-plane 102 of the spokes 100 is offset by 11 mm distance 40 left from the mid-plane 202 of the resilient annular outer band 200 and the tire is tested at 0 degrees camber.

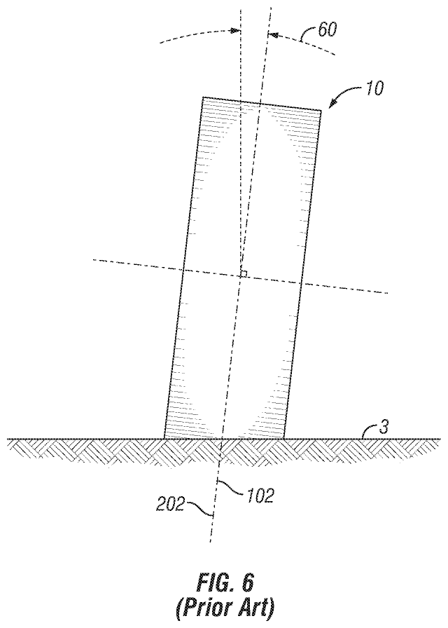

The third of the three designs tested is represented by FIG. 6 wherein the mid-plane 102 of the spokes 100 is aligned with the mid-plane 202 of the resilient annular outer band 200 and the tire is tested at 1 degrees left camber 60.

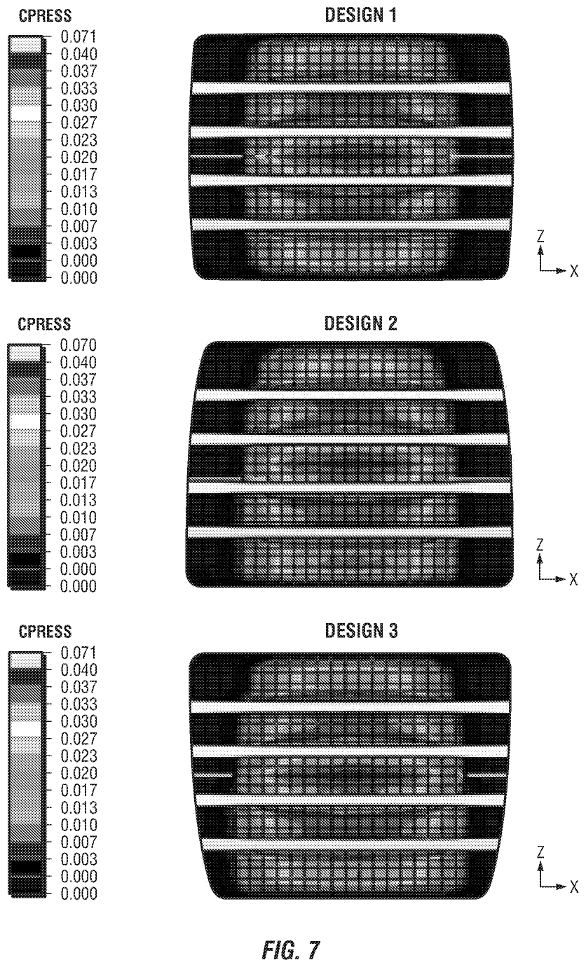

The static footprint measurements, shown in FIG. 7 indicate that the contact pressure shape resulting from second design having the 11 mm spoke offset is similar to the second design having a 1 degree of camber. The length of the footprints was measured to an accuracy of +/−4 mm for each of the designs. For the first design, the center of the tread measured 126 mm long. For the second design having the spokes offset by 11 mm, the length of the right shoulder footprint is 111 mm, the center of the tread was 126 mm and the left shoulder measured 133 mm in length. For the third design, having a camber of 1 degree, the length of the right shoulder footprint is 111 mm, the center of the tread was 126 mm and the left shoulder measured 128 mm in length. The offset spoke design exhibited an outline that possessed a more pronounced trapezoid shape than the 1 degree of camber design while possessing a pressure distribution that was more similar to each other than the first design.

The ground contact pressure fields indicate negligibly small differences in the two designs while the first design, having aligned spokes and zero degree camber is different from either of the other two. This is an indication that the tractive performances like wear, braking, etc., are expected to be the same for the second and third designs.

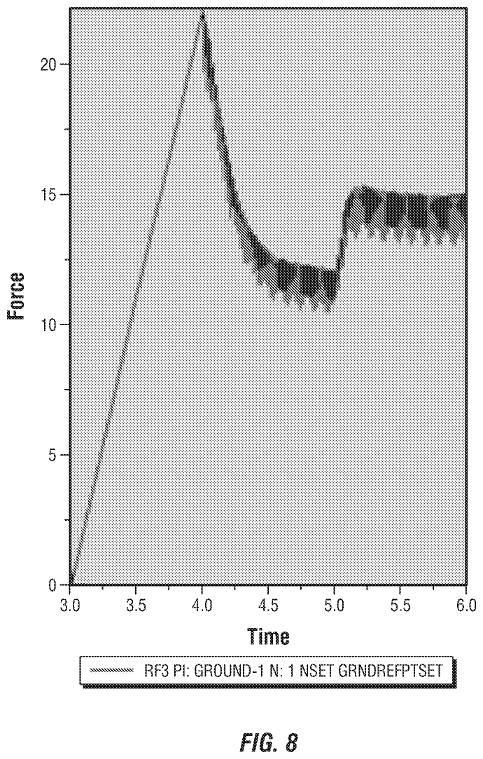

In order to predict the lateral force, the mesh of the finite element model was coarsened and the tire was rolled 600 mm, just long enough to estimate the steady state value of the lateral force of each design such as shown for the third design in FIG. 8. As a result of this modeling, the results for straight rolling of the tire designs with a load of 500 daN normal to the ground surface were less than 0.2 daN for the first design having zero offset and zero camber, 7.8 daN for the second design having an 11 mm spoke offset and for the third design having 1 degree of camber, the test results were between 12 and 15 daN. The generated lateral force by the second design having an 11 mm spoke offset is predicted to be equivalent to about a non-pneumatic tire with no spoke offset and 0.5 degrees of camber.

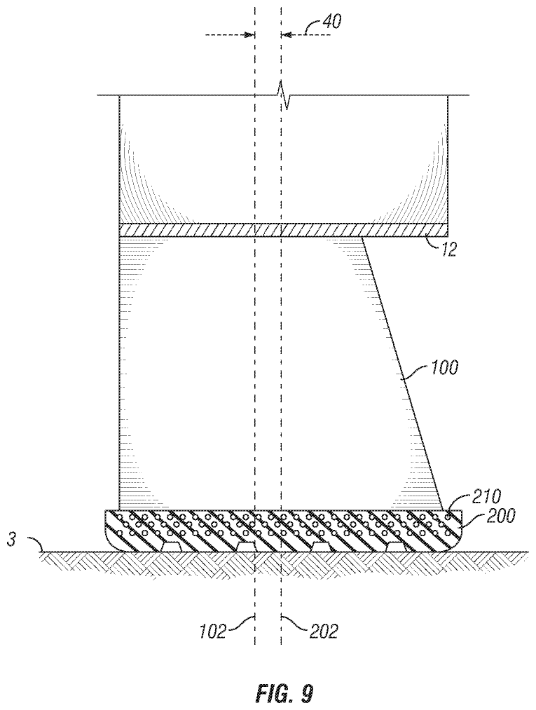

The spoke lateral offset may be realized in other ways and still be within the scope of the invention. For example, where one or more of the lateral edges of the spokes may not lie in a plane parallel to the equatorial plane of the tire. One example of such an embodiment is shown in FIG. 9 where the right lateral edge of the spoke 100 lies at an angle. The lateral offset may be described by locating the lateral mid-plane 102 of the plurality of spokes 100 such that it is parallel to the lateral mid-plane of the resilient annular outer band 200 and located along the axial direction by the average midpoint between the right lateral edge of the spoke 100 and the left lateral edge of the spoke 100 weighted over the radial distance between the radially inner portion 12 and the resilient annular outer band 200 as determined by viewing each spoke from a position normal to the radial plane and intersecting the center of mass of the spoke.

In another method to describe the lateral offset of the plurality of spokes, the lateral mid-plane 102 of the plurality of spokes 100 may be calculated by determining the center of mass of each of the spokes and averaging the lateral distance from the mid-plane 202 of the resilient annular outer band 200.

In another method to describe the lateral offset of the plurality of spokes, the lateral mid-plane 102 of the plurality of spokes may be described by determining the midpoint of the left lateral edge to the right lateral edge of the spoke at the radially inner most point on the spoke 100. While such calculations may be useful to describe the lateral mid-plane of the plurality of spokes 100, it should be understood by a person of ordinary skill in the art that the calculations described will not always result in the same value for the spoke offset.

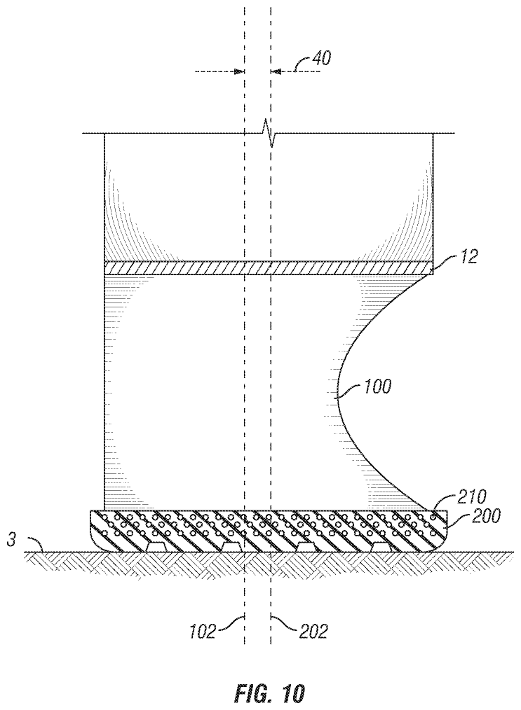

In another embodiment, one or more of the lateral edges of the spokes 100 may not lie in a plane parallel to the equatorial plane of the tire, such as where the lateral edge may appear curved when viewed from a direction perpendicular to the axial and radial direction of the spoke 100 such as shown in FIG. 10. The lateral mid-plane 102 of the plurality of spokes 100 is drawn parallel to the lateral mid-plane of the resilient annular outer band 200 and may be calculated by the average midpoint between the right lateral edge of the spoke 100 and the left lateral edge of the spoke 100 weighted over the radial distance between the radially inner portion 12 and the resilient annular outer band 200.

It should be understood that the spokes may have neither the left nor the right lateral edge lying in a plane parallel to the equatorial plane of the tire. In such cases, both the right and left lateral edges of the spoke may appear curved when viewed from a direction perpendicular to the axial and radial direction of the spoke 100 such as the right lateral edge of the spoke 100 in FIG. 10. Or in other embodiments lateral edges of the spokes may both appear to be angled compared to the equatorial plane when viewed from a direction perpendicular to the axial and radial direction of the spoke 100 such as the right lateral edge of the spoke 100 in FIG. 9.

In FIG. 9 radially inner portion has a radially inner left lateral edge, a radially inner right lateral edge and a radially inner midpoint positioned equidistant between the radially inner left lateral edge and the radially inner right lateral edge. Here, the lateral offset means that the radially inner midpoint of each spoke of the plurality of spokes is laterally offset from the lateral mid-plane of the resilient annular outer band. In other words, the lateral offset is the average distance of the radially inner midpoint of each spoke of the plurality of spokes from the left lateral edge of the resilient annular outer band is not equal to the average distance of the radially inner midpoint of each spoke of the plurality of spokes from the right lateral edge of the resilient annular outer band.

It should be understood the spokes may be interconnected and still be within the scope of the invention, such as where the spokes may form a honeycomb or other pattern. The spokes may be made of a homogeneous material, such as polyurethane, or may be reinforced, such as polyurethane or rubber spokes formed with a fiberglass reinforcements and/or polyester cords.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” Also, the dimensions and values disclosed herein are not limited to a specified unit of measurement.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

1. A non-pneumatic tire comprising:
a resilient annular outer band having a lateral mid-plane positioned equidistant between at least two lateral edges, the at least two lateral edges comprising a left lateral edge and a right lateral edge;
a radially inner annular portion;
a plurality of spokes connecting the resilient annular outer band to the inner annular portion, each spoke having a left lateral edge and a right lateral edge, each spoke extending across the lateral mid-plane of resilient annular outer band;
wherein at least one of said plurality of spokes are laterally offset from the lateral mid-plane of the resilient annular outer band.

2. The non-pneumatic tire of claim 1 wherein at least one spoke possessing a lateral mid-plane and the lateral mid-plane of each spoke is laterally offset from the lateral mid-plane of the resilient annular outer band.

3. The non-pneumatic tire of claim 2 wherein the lateral mid-plane of each spoke of the plurality of spokes is determined as a plane perpendicular to the axial direction and intersecting with the center of mass of the spoke.

4. The non-pneumatic tire of claim 2 wherein the lateral mid-plane of each spoke of the plurality of spokes is determined as a plane perpendicular to the axial direction and representing the radial linear average of the midpoint of the spoke.

5. The non-pneumatic tire of claim 1 wherein at least one spoke possesses a radially inner portion and a radially outer portion, wherein the radially inner portion has a radially inner left lateral edge, a radially inner right lateral edge and a radially inner midpoint positioned equidistant between the radially inner left lateral edge and the radially inner right lateral edge.

6. The non-pneumatic tire of claim 5 wherein lateral offset means that the radially inner midpoint of each spoke of the plurality of spokes is laterally offset from the lateral mid-plane of the resilient annular outer band.

7. The non-pneumatic tire of claim 6 wherein lateral offset means that the average distance of the radially inner midpoint of each spoke of the plurality of spokes from the left lateral edge of the resilient annular outer band is not equal to the average distance of the radially inner midpoint of each spoke of the plurality of spokes from the right lateral edge of the resilient annular outer band.

8. The non-pneumatic tire of any one of the above claims wherein each spoke of the plurality of spokes are laterally offset from the lateral mid-plane of the resilient annular outer band by an equal distance.

9. The non-pneumatic tire of any one of the above claims wherein the average position of each spoke of the plurality of spokes is laterally offset from the lateral mid-plane of the resilient annular outer band.

10. The non-pneumatic tire of any one of the above claims wherein the left lateral edge of each spoke lies in a plane parallel to the lateral mid-plane of the resilient annular outer band and the right lateral edge of each spoke lies in a plane parallel to the lateral mid-plane of the resilient annular outer band.

11. The non-pneumatic tire of any one of the claim 1 through claim 9 wherein one of either the right or left lateral edge of at least one spoke lies in a plane parallel to the lateral mid-plane of the resilient annular outer band and the other of either the right or left lateral edge of at least one spoke does not lie in a plane parallel to the lateral mid-plane of the resilient annular outer band.

12. The non-pneumatic tire of any one of the claim 1 through claim 9 wherein both the left and right lateral edge of at least one of said plurality of spokes does not lie in a plane parallel to the lateral mid-plane of the resilient annular outer band.

13. A non-pneumatic tire comprising:
a resilient annular outer band having a lateral mid-plane positioned equidistant between at least two lateral edges, the at least two lateral edges comprising a left lateral edge and a right lateral edge;
a radially inner annular portion;
a plurality of spokes connecting the resilient annular outer band to the inner annular portion, each spoke having a left lateral edge and a right lateral edge, each spoke extending across the lateral mid-plane of resilient annular outer band;
wherein at least one of the plurality of spokes is asymmetric in reference to the lateral mid-plane of the resilient annular outer band.

14. The non-pneumatic tire of claim 13 wherein at least one of said plurality of spokes are laterally offset from the lateral mid-plane of the resilient annular outer band.

15. The non-pneumatic tire of any one of the claim 13 or 14 wherein one of either the right or left lateral edge of at least one spoke lies in a plane parallel to the lateral mid-plane of the resilient annular outer band and the other of either the right or left lateral edge of at least one spoke does not lie in a plane parallel to the lateral mid-plane of the resilient annular outer band.

16. A non-pneumatic tire comprising:
a resilient annular outer band having a lateral mid-plane positioned equidistant between at least two lateral edges, the at least two lateral edges comprising a left lateral edge and a right lateral edge;
a radially inner annular portion;
a single lateral row of a plurality of spokes connecting the resilient annular outer band to the inner annular portion, each spoke having a left lateral edge and a right lateral edge;
wherein at least one of said plurality of spokes are laterally offset from the lateral mid-plane of the resilient annular outer band.

16. The non-pneumatic tire of claim 1 wherein at least one spoke possessing a lateral mid-plane and the lateral mid-plane of each spoke is laterally offset from the lateral mid-plane of the resilient annular outer band.

17. The non-pneumatic tire of claim 2 wherein the lateral mid-plane of each spoke of the plurality of spokes is determined as a plane perpendicular to the axial direction and intersecting with the center of mass of the spoke.

18. The non-pneumatic tire of claim 2 wherein the lateral mid-plane of each spoke of the plurality of spokes is determined as a plane perpendicular to the axial direction and representing the radial linear average of the midpoint of the spoke.

19. The non-pneumatic tire of claim 1 wherein at least one spoke possesses a radially inner portion and a radially outer portion, wherein the radially inner portion has a radially inner left lateral edge, a radially inner right lateral edge and a radially inner midpoint positioned equidistant between the radially inner left lateral edge and the radially inner right lateral edge.

20. The non-pneumatic tire of claim 5 wherein lateral offset means that the radially inner midpoint of each spoke of the plurality of spokes is laterally offset from the lateral mid-plane of the resilient annular outer band.
